(19) United States
(12) Patent Application Publication
(10) Pub. No.: US 2012/0029985 A1
(43) Pub. Date: Feb. 2, 2012

(54) System And Method For Managing Recyclable Materials

(75) Inventors: Chad Scott Wilson, Pleasanton, CA (US); John Magagnini, Pleasanton, CA (US)

(73) Assignee: Neptune Rewards, LLC, Pleasanton, CA (US)

(21) Appl. No.: 12/948,645

(22) Filed: Nov. 17, 2010

Related U.S. Application Data
(60) Provisional application No. 61/400,473, filed on Jul. 27, 2010.

(51) Int. Cl. G06Q 30/00; G06Q 10/00

(52) U.S. Cl. 705/14.11; 705/308

(57) ABSTRACT

The disclosure relates to a system and method for receiving recyclable materials, associating the materials with a specific user, capturing data specific to that user and the materials, and providing reward points to the user based on the materials.

### PRIORITY CLAIM

This application claims the benefit under 35 U.S.C. Section 119(e) to U.S. Provisional Patent Application 61/400,473 filed on Jul. 27, 2010 and entitled “Recycling Material Characterization Process and Method Thereof,” which is incorporated by reference herein.

### FIELD

The disclosure relates to a system and method for receiving recyclable materials, associating the materials with a specific user, capturing data specific to that user and the materials, and providing reward points to the user based on the materials.

### BACKGROUND

During the past several years, there has been a tremendous movement to develop “green” technologies and to optimize the use of physical resources. An important component of this movement is recycling. It is well-known that aluminum cans, paper, cardboard, and other materials can be recycled. It is common for refuse companies to pick up recyclable materials from homes and businesses (often placed in separate crates by individuals prior to pick-up). There is a substantial industry involved in the purchase of recyclable materials from refuse companies and the actual recycling of those materials.

However, a significant volume of recyclable material still is placed by individuals in normal trash cans. For example, individuals often place aluminum soda cans in a trash can instead of a recycling can. Unless another individual sorts through the contents of that trash can, the aluminum soda can will not be recycled and ultimately will be placed in a landfill, which takes up precious space and results in that aluminum not being reused. There is a tremendous need for greater incentives for individuals to recycle all materials that are recyclable. There is also a tremendous need for companies and facilities to track the amount and type of recycling that is performed by each individual and collections of individuals.

### SUMMARY OF THE INVENTION

It is desirable to provide a method and apparatus for receiving recyclable materials, associating those materials with a specific user, storing information about the materials and user, capturing data specific to that user and the materials, and providing reward points to the user based on the materials. It also is desirable to generate reports about a user's recycling patterns and history, as well as reports about collections of users (such as employees of a corporation).

### BRIEF DESCRIPTION OF THE DRAWINGS

FIG. 1 illustrates an exemplary recycling apparatus.

FIG. 2 illustrates components of an exemplary recycling apparatus.

FIG. 3 illustrates components of an exemplary recycling apparatus.

FIG. 4 illustrates a computing device and database for use with an exemplary recycling apparatus.

FIG. 5 illustrates components of an exemplary recycling apparatus.

FIG. 6 illustrates a method of associating recycling activity with a user.

FIG. 7 illustrates an exemplary database table.

FIG. 8 illustrates an exemplary map showing locations of recycling apparatuses.

### DETAILED DESCRIPTION OF ONE OR MORE EMBODIMENTS

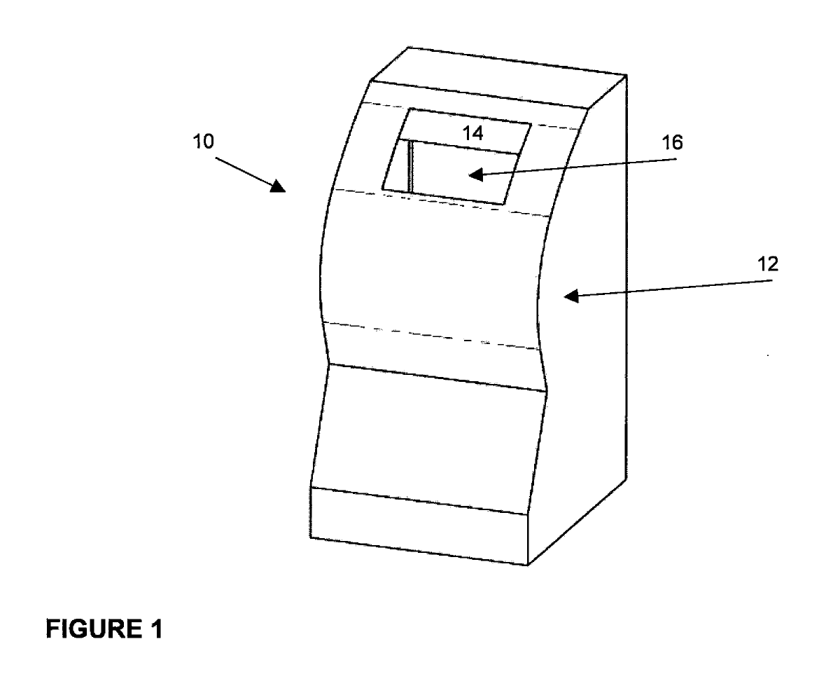

An embodiment is depicted in FIG. 1. Recycling apparatus 10 comprises a chassis 12, which can be constructed of plastic, metal, or any other solid material. Chassis 12 contains an opening 16 through which users can place recyclable materials, as will be described in further detail below. There are dozens of recyclable materials, examples of which are listed in Appendix 1. Opening 16 optionally can be covered by a door 14 that covers opening 16 and can swing or move open to allow the user to place recyclable materials through opening 16.

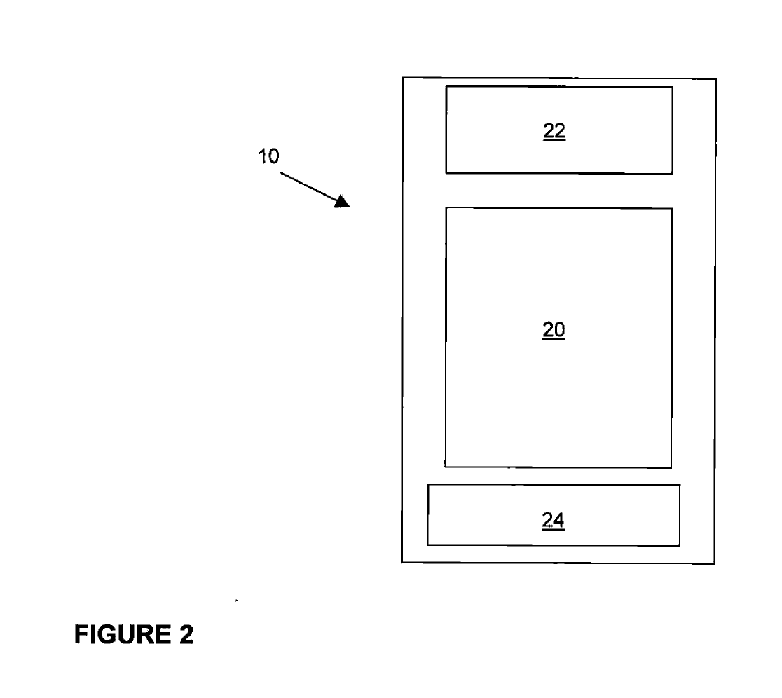

FIG. 2 shows further aspects of the embodiment. Recycling apparatus 10 includes within it receptacle 20 used to receive and store the recyclable materials. Opening 16 is positioned in relation to receptacle 20 so that the recyclable materials enter or are placed into receptacle 20 during normal operation. Receptacle 20 optionally is placed over weighing mechanism 24. Weighing mechanism 24 can comprise a scale (such as an electronic or electromechanical scale) to be used to weigh the contents of receptacle 20, as discussed below. Recycling apparatus 10 further comprises compartment 22, which can be used to hold electronic components used in operation of recycling apparatus 10.

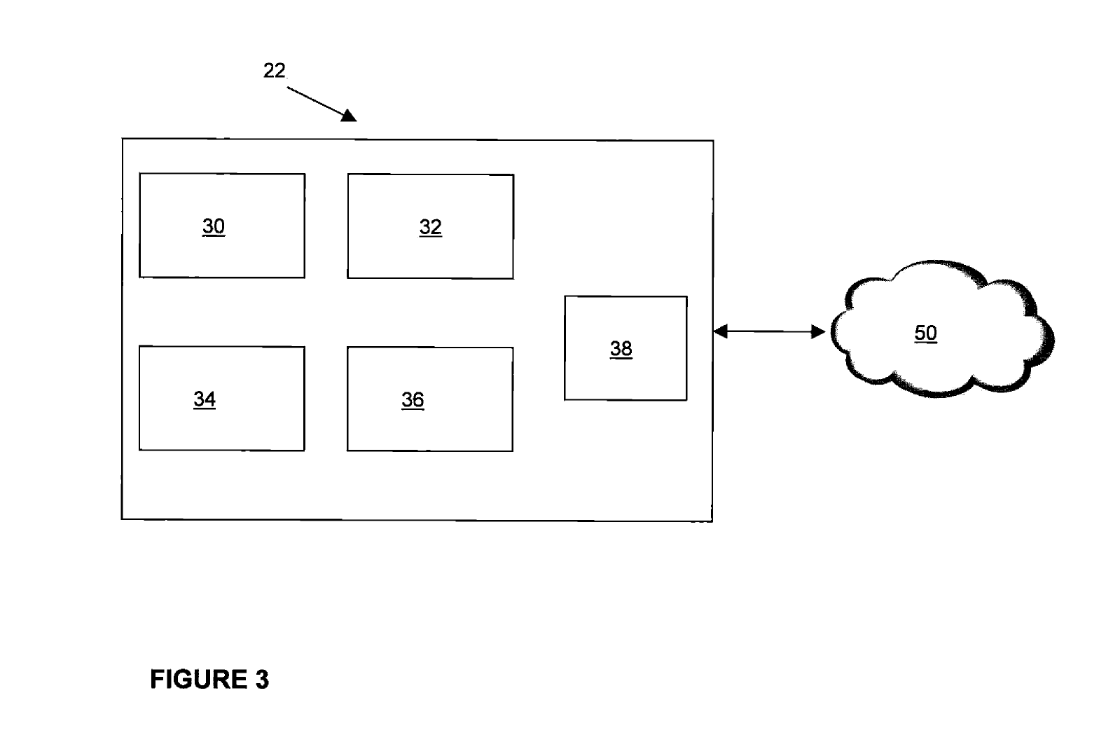

FIG. 3 shows a logical diagram of exemplary electrical components of the embodiment. The electrical components are shown within compartment 22, but can be placed in any other location. Recycling apparatus 10 comprises processing unit 30. Processing unit optionally can comprise a general purpose computer (such as a laptop or netbook computer), a processor chip (such as an Intel Pentium® Dual Core chip), or other programmable logic. Processing unit 30 is coupled to display controller 32. Display controller 32 is used to control a video display used by the user to interact with recycling apparatus 10. Display controller 32 is coupled to a display (not shown) that display graphics and text for the user to interact with. Processing unit 30 is coupled to input device 34. Input device 34 is used to obtain input from a user and can comprise a keyboard, keypad, mouse, touchpad, bar code scanner, card reader, or other device. Processing unit 30, display controller 32, and input device 34 can be coupled to each other through a bus (such as a PCI bus, PCI Express bus, or USB bus), through a connector (such as a USB, firewire, serial port, parallel port, WiFi, or other connector), or through a switch, router, hub, or network.

Recycling apparatus 10 comprises GPS unit 36. GPS units are well-known in the art and are commonplace in modern smartphones and automobiles. GPS unit 36 can be used by an administrator to keep track of the physical location of recycling apparatus 10. GPS unit 36 can comprise a GPS SIM Cellular Card.

Recycling apparatus 10 further comprises network interface 38. Network interface 38 enables recycling apparatus 10 to communicate over network 50. Network 50 can be the Internet or a LAN, WAN, Intranet, wireless, landline, cellular, or other network. Network interface 38 can comprise a WiFi card (such as an IEEE 802.11 wireless interface card), a cellular telephone transceiver or transmitter (such as a 3G, 4G, CDMA, GSM, GPRS, EDGE, or HSDPA transceiver or transmitter), an Ethernet interface, a UPS SIM Cellular Card, or other network interface.

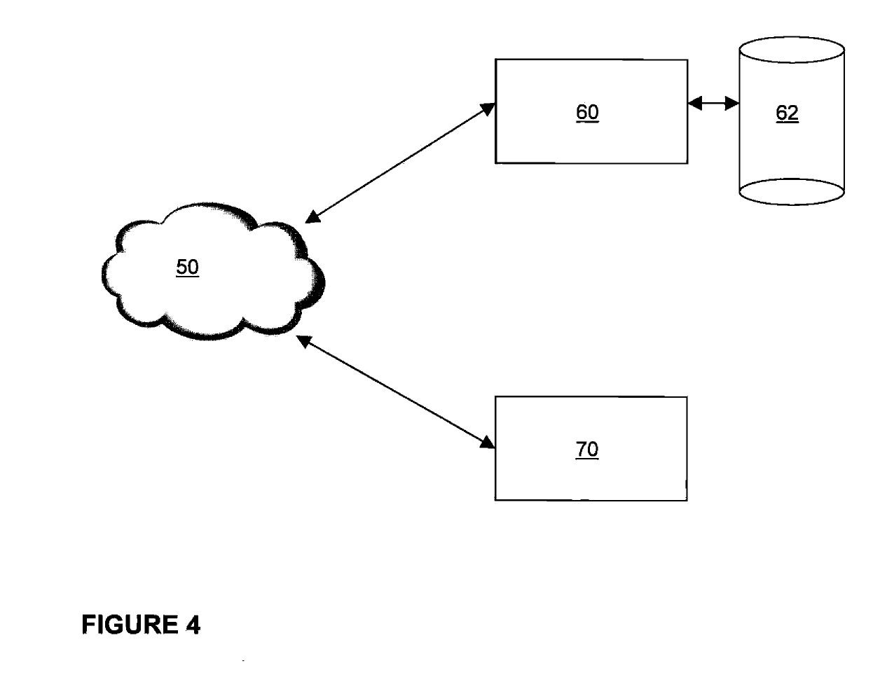

FIG. 4 depicts another aspect of an embodiment. Computing device 60 is coupled to network 50. Computing device 60 can communicate with recycling apparatus 10 via network 50. Computing device 60 can be one or more general purpose servers, desktop computers, notebook computers, or any other type of computer capable of performing the functions described herein as to computing device 60. Computing device 60 contains or is coupled to database 62. Database 62 can be, for example, a relational database such as an SQL database. Other computing devices, such as computing device 70, also are coupled to network 50 and optionally can communicate with recycling apparatus 10 and/or computing device 60. For example, an administrator could use computing device 70 to perform management operations (such as by a Web interface or management software) to control or interact with computing device 60 or recycling apparatus 10.

In an alternative embodiment, the user's mobile device can be used to communicate with computing device 60. The mobile device can run an application that receives data, such as weight deposited or reward point value, from recycling apparatus 10. The mobile device can then use its wireless capability to transmit the data to computing device 60 through any number of mechanisms available to a mobile device, such as email, SMS text message, or direct API communication.

In an alternative embodiment, processing unit 30 can be located outside of recycling apparatus 10 in a different unit. In this alternative embodiment, recycling apparatus 10 can include an RF module such as the XBee 802.15.4 OEM RF module, which will enable recycling apparatus 10 to communicate with a similar RF module located elsewhere that is coupled to processing unit 30. This approach would reduce the cost of manufacturing and maintaining each recycling apparatus 10 and would enable multiple recycling apparatuses to share a single processing unit 30.

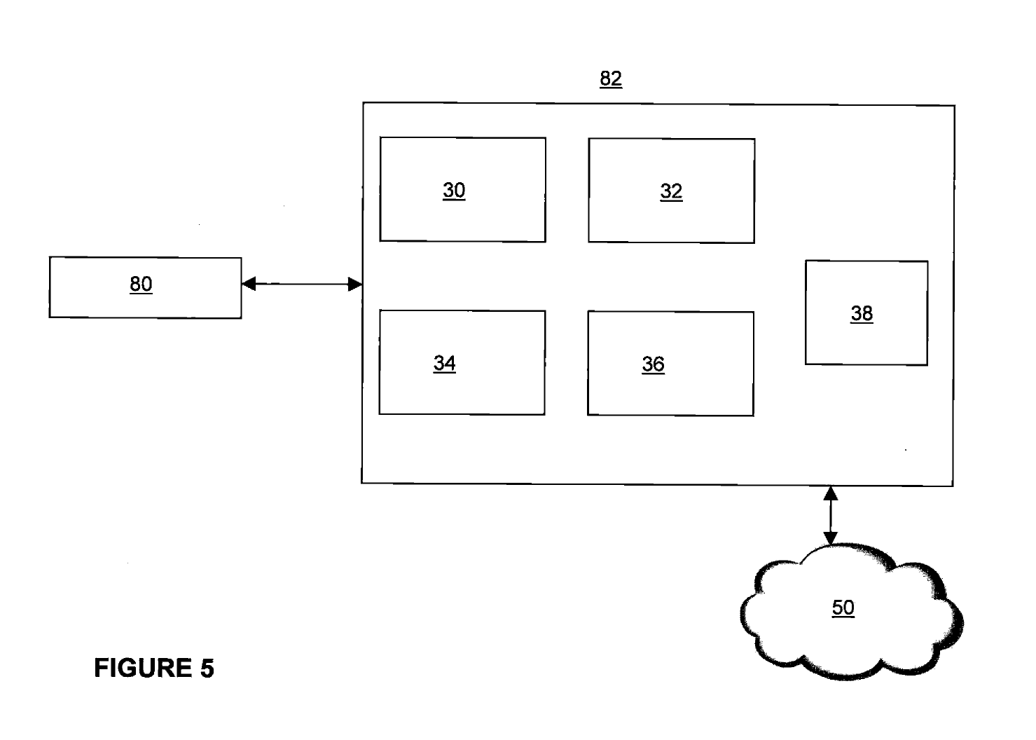

Another alternative embodiment is shown in FIG. 5. Scale 80 is coupled to control unit 82. Scale 80 can be used to weigh various recyclable materials, such as bales of cardboard at a distribution center or large retail store. Control unit 82 can include one or more of the electrical components previously described with respect to FIG. 3: processing unit 30, display controller 32, input device 34, GPS unit 36, and network interface 38. The functionality of those components is the same as described previously with respect to FIG. 3. Scale 80 is coupled to network 50. As described below, control unit 82 can be used to associate recyclable materials with a particular user and to provide reward points to that user.

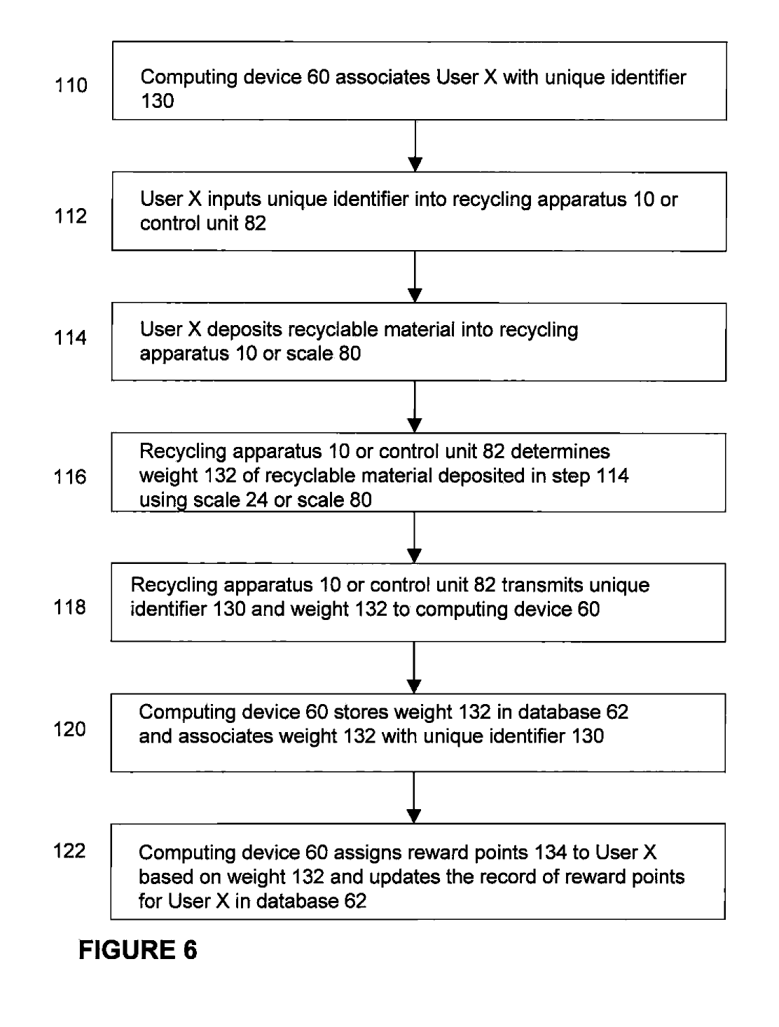

FIG. 6 describes an embodiment of a method of using recycling apparatus 10 or control unit 82. Computing device 60 associates User X with unique identifier 130 (110). Unique identifier 130 can comprise characters assigned to User X by computing device 60 or it can comprise a preexisting identifier for User X, such as a mobile phone number or email address. Thereafter, User X can utilize recycling apparatus 10 or control unit 82. User X inputs his or her unique identifier into recycling apparatus 10 or control unit 82 (112). User X deposits recyclable material into recycling apparatus 10 or onto scale 80 (114). Recycling apparatus 10 or control unit 82 determines the weight 132 of the recyclable material deposited in step 114 using scale 24 (116). Recycling apparatus 10 or control unit 82 transmits unique identifier 130 and weight 132 to computing device 60 (118). Computing device 60 stores weight 132 in database 62 and associates weight 132 with unique identifier 130 (120). Computing device 60 assigns reward points 134 to User X based on weight 132 and updates the record of reward points for User X in database 62 (122).

The reward points are determined based upon a predetermined formula, such as 5 points for each pound of recyclable material placed in recycling apparatus 10, or 5 points for each act of depositing recyclable material into recycling apparatus 10. The administrator of computing device 60 can create any number of programs for redeeming the reward points. For example, the administrator can set thresholds for different prizes, such a $5 gift card for each 100 reward points obtained. Computing device 60 can transmit prizes to users automatically when the thresholds are reached, such as by emailing a gift certificate to a user. An administrator also can establish an “open loop” reward system (such as a debit card) to which a user's reward points (or equivalent value) are added either periodically (e.g., at the end of each week) or at the occurrence of an event (e.g., when the user accumulates 100 reward points). An administrator also can establish a “closed loop” reward system (such as a gift card) to which a user's reward points (or equivalent value) are added only one time; thereafter, once the user consumes all of the reward points, the gift card or other closed loop mechanism will have no value and will be discarded by the user.

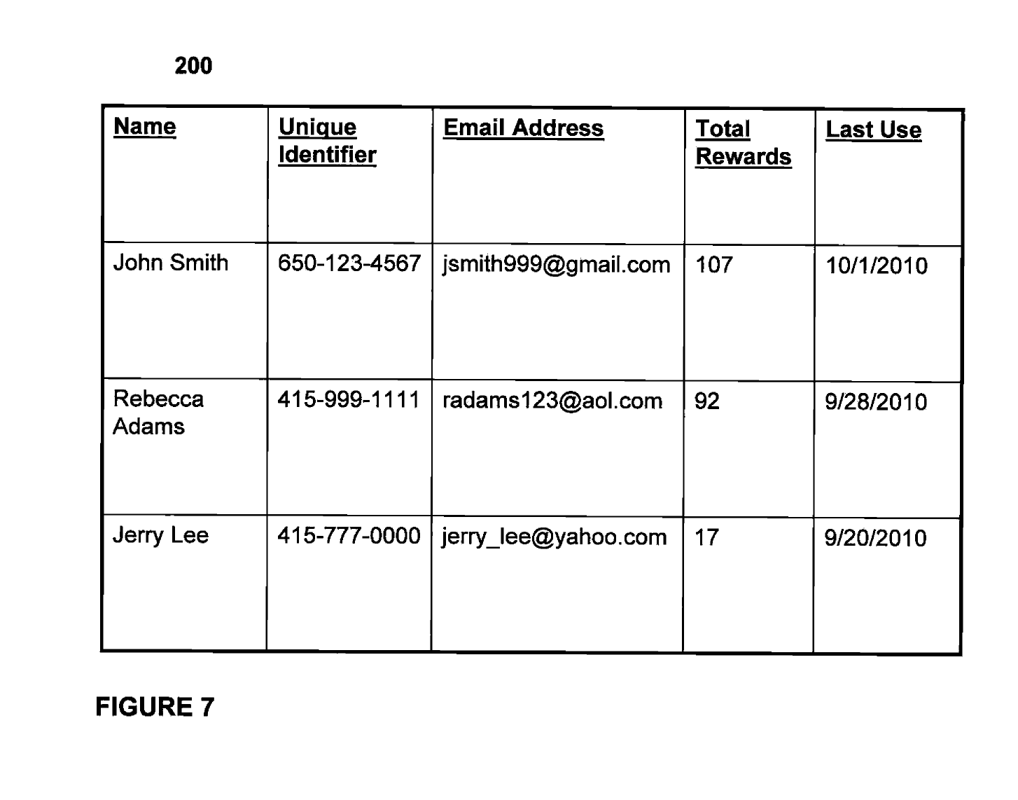

FIG. 7 depicts exemplary table 200 maintained by database 62. Table 200 includes fields for user name, unique identifier 130, email address, total rewards, and date of last use. Other fields not depicted that can be maintained by database 62, either in Table 200 or elsewhere, include company name, facility address, collection address, company contact information, user contact information, company tax information, user tax information, company SIC code, user SIC code, company billing information, user password, GPS coordinates for recycling apparatus 10, identifier for recycling apparatus 10, communications box number, target volume level per month or year, cumulative weight collected, customer diversion performance, material condition (loose or baled), waste hauler information, recycling hauler or purchaser information, collection usage for recycling apparatus 10, total weight collected over a given time period, total point values paid to all users or per user, type of redemptions made in past, average weight collected, type of material collected, carbon offset credit points associated with recyclable materials collected, percentage of energy savings, reduction of green house gases emissions in metric tons, carbon footprint diversion in metric tons, landfill diversion in pounds, water energy, status of recycling apparatus (active, inactive), number of reward points to be granted for each unit of each type of recyclable material (e.g., 10 points for every pound of aluminum cans, or 10 points for every pound of any material). These fields are only exemplary.

The number and type of reward points granted for each unit of each type of recyclable material deposited into recycling apparatus 10 or scale 80 can vary from customer site to customer site. It would be useful to perform a waste audit at a company site before the reward point system is established. In a waste audit, a refuse company will go through all of the recycling bins at the company site over a set time period (e.g., one week), and will quantify each type of recyclable materials deposited into those bins. The refuse company also will go through all of the trash cans at the company site over the same time period to quantify each type of recyclable materials that were deposited into the trash cans, which would represent a loss of recycling opportunity, and for the company, the loss of potential revenue or disposal cost savings from recycling the materials. Once this waste audit is perform, one can estimate the amount of recycling revenue or disposal cost savings that can be gained at the company site by implementing one of the embodiments per time period (e.g., $10,000 per month). Once that value is determined, one can examine the number of employees at the company site and determine an appropriate value to spend on reward points per unit of time, and one can then set the appropriate number of reward points to be granted for each unit of each type of recyclable material. In this manner, the reward point system can be customized for each company based on its existing recycling habits and potential recycling revenue or disposal cost savings to be achieved. For example, if a give company has a large potential recycling revenue or disposal cost savings to be achieved (because its employees have bad recycling habits), then that company can grant more reward points for a given amount of recyclable material than may be the case at other companies.

Computing device 60 also can collect and store information about recycling apparatus 10, such as remaining battery life (if recycling apparatus 10 is battery-powered), solar power output performance (if recycling apparatus 10 is battery-powered and recharged by a photoelectric solar cells array), signal performance (if recycling apparatus 10 is utilizing a wireless connection to network 50), capacity used or capacity remaining, or an indication that the recycling apparatus 10 is overweight (which might be an indication that a user is trying to manipulate the rewards system by putting heavy, non-recyclable material into recycling apparatus 10, such as a load of bricks). Each recycling apparatus 10 also will have its own identifier.

The administrator of computing device 60 and the recycling apparatuses can receive reports from database 62 that reflect the data collected by each recycling apparatus or collection of recycling apparatuses. For example, computing device 60 or database 62 can send an hourly, daily, or monthly report indicating aggregate information (such as total weight collected across an entire facility or company and total number of users who made deposits) and/or information specific to each user (such as weight collected for each user and frequency of deposits for each user). Computing device 60 or database 62 also can send reports to each user containing similar information. Reports can be sent through an email, SMS text message, or a dedicated application (such as an iPhone application). The same data also can be communicated to an administrator or user through a Web interface.

Recycling apparatus 10 also can send other data or communications to computing device 60. For example, recycling apparatus 10 can send an alert to computing device 60 when the total weight detected by scale 24 reaches a certain threshold (e.g., 50 pounds), which can indicate that recycling apparatus 10 is nearing its capacity. Computing device 60, in turn, can then send a message (such as an email, SMS message, or phone call) to custodial personnel to inform them that recycling apparatus 10 needs to be emptied. Recycling apparatus 10 also can send an alert to computing device 60 if recycling apparatus 10 needs other servicing, such as battery replacement or computer maintenance.

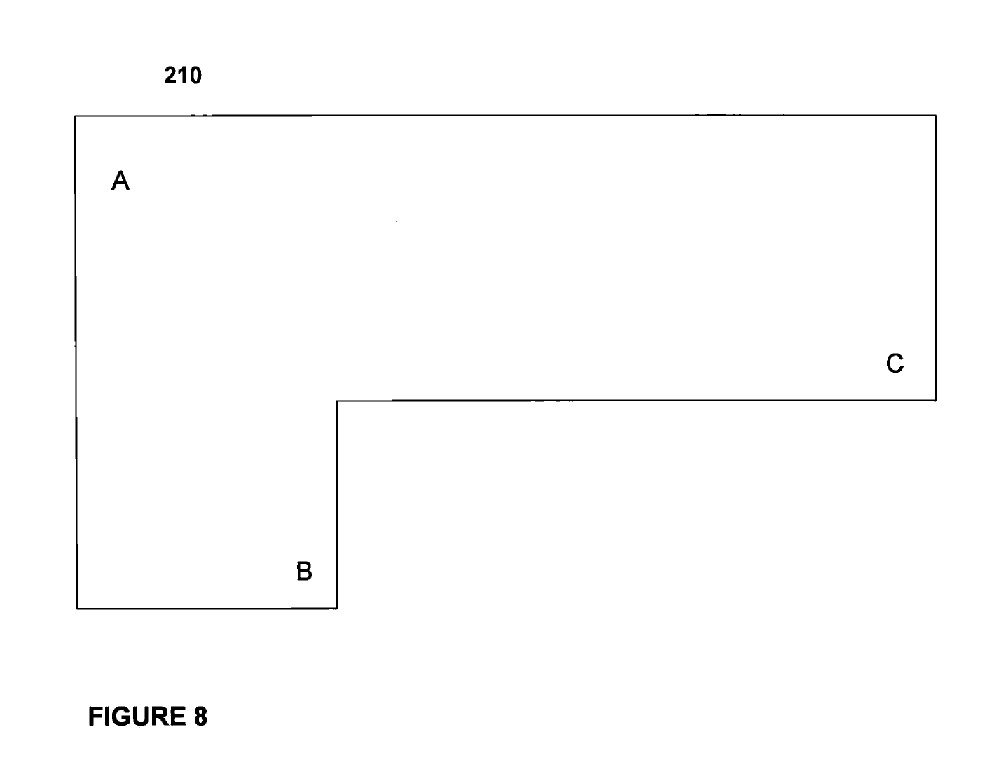

As discussed previously, recycling apparatus 10 optionally includes GPS unit 36. Computing device 60 can run management software that enables an administrator to monitor all recycling apparatuses being used. For example, FIG. 8 depicts an exemplary map 210 of a physical facility. Map 210 shows the physical location of three recycling apparatuses, labeled A, B, and C. The physical location of each recycling apparatus is known due to the use of GPS unit 36 in each recycling apparatus. Management software optionally can depict additional information about each recycling apparatus, such as time of last use, frequency of use over a given time period, number of different users who have used the recycling apparatus over a given time period, date and time of last service of recycling apparatus by a custodian, weight of current contents of recycling apparatus, and percent of total capacity being used or available. This type of management software features would be particularly useful in large commercial facilities, athletic stadiums, college campuses, and theme parks. In exemplary map 210, when a recycling apparatus is full, the identifier or icon associated with that recycling apparatus can be displayed in red, with highlighting, or in a blinking manner to indicate to the administrator that the recycling apparatus needs to be emptied.

Optionally, a company can use a plurality of recycling apparatuses, each for a dedicated purpose (paper, cans, etc.). This would enable computing device 60 to identify and store data concerning the specific type of materials deposited by each user. This could enable the company to identify trends in the materials used by a user or the company as a whole. For example, it could identify users who recycle an inordinate amount of paper, which would present an opportunity for cost-cutting if management can change the printing habits of those users.

Other methods can be utilized to determine the content of material recycled by a given company. For example, one can perform a physical inspection of a sample of material collected in the recycling apparatuses. To determine an accurate generation rates of any business, residential, multi-family, community, special event, or other entity, it is required that all materials listed below be broken down into sub-categories and their corresponding weights and volumes be collected from the source sample. The proper method for determining the weight or volume percentage of each grade is to take a sample load, sort and separate all materials by individual grade, and measure the separated content weight and/or volume by material grade. These numbers will then be used to determine the percentage breakdown of materials by grade from a random source. For example, one can determine the weight of all paper in the sample, then divide that weight by the total weight of the sample and multiply the result by 100 to determine the percentage by weight of the sample that constitutes paper.

The data collected using these embodiments also can be used in conjunction with social networking and other social interactions. Each user and company can be assigned a personalized web page that shows the progress of the user or company and compares the data collected against other users, companies, or an aggregation of other users or companies. This web page can show the total weight of aluminum, glass, plastic, paper, or other materials (or all materials without regard to type) that the user or company has recycled as well as the CO2 saved as a result of that recycling (i.e., reduction in carbon footprint). All of this progress can be graded on a “Green Level” scale by number and/or by name (e.g., “John Magagnini has reached a Green Level of 68”). The web page can be hosted on a networked computing device, which can comprise one or more general purpose servers, desktop computers, notebook computers, or any other type of computer capable of hosting a web page. In the alternative, the same information can be displayed using a mobile device application rather than a web page.

In addition, the web page or mobile device application can be configured to display tools that link the page to social networking sites such as Facebook® and Twitter®. With a click of the button, a user (or company) can update its status and communicate that new status to all of their friends, followers, colleagues family, and other persons who are part of that user's social networks. The status update can include data collected using the above embodiments. For example, a post could read, “John Magagnini has reached a Green. Level of 68 and diverted 335 pounds from landfill, and avoided the creation of 0.51 metric tons of Greenhouse Gas (GHG) emissions and 350 pounds of CO2. Take the Neptune Rewards Challenge and try to catch John.” In addition, a number of canned statuses could be used, such as “John Magagnini has saved 23 pounds of plastic from reaching our oceans and landfills. Take the Neptune Rewards Challenge and help save the environment.” This application can be used to create competitiveness, rivalries, and a “Social Community” atmosphere among business and users.

While the foregoing has been with reference to a particular embodiment of the disclosure, it will be appreciated by those skilled in the art that changes in this embodiment may be made without departing from the principles and spirit of the disclosure, the scope of which is defined by the appended claims.

### APPENDIX 1

A. Paper
1. Old Corrugated Containers
2. Special Old Corrugated Containers
3. Wax Board or Dry-Fast Medium
4. Offshore Corrugated
5. Office Paper
6. Newsprint
7. Mixed Paper
8. Kraft Board Stock
9. Aseptic Packaging
10. Other Paper Stock

B. Plastics
1. PET Beverage Containers (Non-Deposit)
2. PET Beverage Containers (Deposit)
3. HDPE Bottles/Containers
4. Mix Plastics (#1-7#)
5. Mixed Rigid Plastics
6. Plastic Film/Wrap
7. Plastic Strapping
8. Polystyrene
9. Polypropylene
10. PVC (Polyvinal Chloride)
11. ABS
12. Other Plastics (non-recyclable)
13. Other Plastics (specialty, recyclable)
14. Carpet (PET)

C. Metals
1. Aluminum Cans (Non-Deposit)
2. Aluminum Can (Deposit)
3. Tin Cans
4. Other Ferrous
5. Other Non-Ferrous
6. Mixed Metals/Other Metals

D. Glass
1. Green (Non-Deposit)
2. Amber (Non-Deposit)
3. Clear (Non-Deposit)
4. Green (Deposit)
5. Amber (Deposit)
6. Clear (Deposit)
7. Window/Tempered Glass
8. Other Mixed Glass (unidentifiable)

E. Organics
1. Food Waste
2. Yard Trimmings
3. Biodegradable Bags and Utensils

F. Other Organic Materials
1. Textiles (Cotton)
2. Carpet (wool)
3. Miscellaneous Organics

G. Inorganics
1. Asphalt Roofing
2. Asphalt Paving
3. Gypsum Board
4. Concrete
5. Sand/Soil/Rock/Dirt
6. Ceramics
7. Miscellaneous Inorganics

H. Wood
1. Untreated Wood
2. Treated Wood
3. Pallets
4. Stumps

I. Batteries
1. Lithium
2. NiCad
3. Alkaline
4. Lead Acid

J. Electronics
1. CRT and Monitors
2. PC's
3. TV's
4. Other Electronic Devices

K. Other Waste
1. Furniture
2. Appliances
3. Tires

L. HHW (Household Hazardous Waste)
1. Pesticides/Herbicides
2. Paint/Adhesives/Solvents
3. Household Cleaners
4. Automotive Products
5. Other HHW

M. Other Material

1. A system for collecting and measuring recyclable material and providing reward points, comprising:
a recycling apparatus comprising a chassis that contains a receptacle for receiving recyclable material, an input device for receiving a unique identifier for a user, a weighing mechanism for determining the weight of material placed in the receptacle by the user, and a network interface card; and
a network coupled to the network interface card to enable communication with a server,
wherein the server is configured to assign reward points to the user based on the weight of material placed in the receptacle by the user.

2. The system of claim 1, wherein the server is configured to send an alert when the total weight of material in the receptacle exceeds a predetermined threshold.

3. The system of claim 1, wherein the server contains or is coupled to a database.

4. The system of claim 1, wherein the reward points are provided to the user through a closed-loop reward system.

5. The system of claim 1, wherein the reward points are provided to the user through an open-loop reward system.

6. The system of claim 1, wherein the recycling apparatus further comprises a GPS unit to enable the system to determine the location of the recycling apparatus.

7. The system of claim 6, wherein the server is configured to generate a graphical map showing the location of the recycling apparatus.

8. The system of claim 7, wherein the graphical map shows status information for the recycling apparatus.

9. The system of claim 8, wherein the status information indicates if the recycling apparatus is full.

10. The system of claim 8, wherein the status information indicates if the recycling apparatus is in operational condition.

11. A method for collecting and measuring recyclable material in a recycling apparatus and providing reward points, comprising:
receiving a unique identifier for a user through an input device on a chassis of a recycling apparatus;
receiving recyclable material in a receptacle in the chassis from the user through an opening in the chassis;
determining the weight of the recyclable material using a weighing mechanism in the chassis;
transmitting the unique identifier and weight to a server using a network interface card contained in the recycling apparatus coupled to a network; and
assigning reward points to the user based on the weight of material placed in the receptacle by the user.

12. The method of claim 11, wherein the method further comprises the step of sending an alert when the total weight of material in the receptacle exceeds a predetermined threshold.

13. The method of claim 11, wherein the server contains or is coupled to a database.

14. The method of claim 11, wherein the assigning step comprises providing reward points to the user through a closed-loop reward system.

15. The method of claim 11, wherein the assigning step comprises providing reward points to the user through an open-loop reward system.

16. The method of claim 11, wherein the recycling apparatus further comprises a GPS unit to enable the system to determine the location of the recycling apparatus.

17. The method of claim 16, wherein the method further comprises the step of the server generating a graphical map showing the location of the recycling apparatus.

18. The method of claim 17, wherein the graphical map shows status information for the recycling apparatus.

19. The method of claim 18, wherein the status information indicates if the recycling apparatus is full.

20. The method of claim 18, wherein the status information indicates if the recycling apparatus is in operational condition.
